(19) United States
(12) Patent Application Publication
(10) Pub. No.: US 2024/0158292 A1
(43) Pub. Date: May 16, 2024

(54) ANTI-REFLECTIVE INFRARED TRANSMITTING LAMINATE GLASS ARTICLES WITH A POROUS LAYER

(71) Applicant: CORNING INCORPORATED, Corning, NY (US)

(72) Inventors: Venkatesh Botu, Corning, NY (US); Attila Lang de Falussy, Elmira, NY (US)

(21) Appl. No.: 18/284,314

(22) PCT Filed: Mar. 29, 2022
(86) PCT No.: PCT/US2022/022297

§ 371 Date: Sep. 27, 2023

Related U.S. Application Data
(60) Provisional application No. 63/167,799, filed on Mar. 30, 2021.

(51) Int. Cl. C03C 17/02; C03C 11/00; C03C 15/00

(52) U.S. Cl. CPC C03C 17/02; C03C 11/005; C03C 15/00; C03C 2217/452; C03C 2218/33

(57) ABSTRACT

A laminated glass article having a glass core and at least one glass cladding fused to the glass core, the cladding having a porous region at an outer surface thereof. The laminated glass article has a transmittance across an entire spectrum from 875 nm to about 2000 nm that is greater than or equal to 97%, and that has a reflectance across an entire spectrum from 875 nm to 2000 nm that is less than or equal to 3.0%. A method for forming a laminated glass article includes obtaining a laminated glass article have a glass core and a cladding, and heating the laminated glass article to form a phase-separated cladding having an interconnected matrix with discrete dispersed regions. The phase-separated cladding layer is etched to remove the discrete dispersed regions, thereby forming a porous region at a surface of the phase-separated cladding.

### CROSS REFERENCE TO RELATED APPLICATIONS

This application claims the benefit of priority under 35 U.S.C. § 119 of U.S. Provisional Application No. 63/167,799, filed on Mar. 30, 2021, the content of which is relied upon and incorporated herein by reference in its entirety.

### BACKGROUND

### Field

The present specification generally relates to laminated glass articles and, more specifically, to laminated glass articles having a porous layer that allows the laminated glass article to be antireflective and transmit infrared (IR) radiation.

### Technical Background

LiDAR technology is gaining interest in many industries, including the automotive industry for autonomous vehicles. There are two broad categories at which LiDAR lasers operate; wavelengths around 905 nm and wavelengths around 1550 nm. There are a few characteristics of articles that are particularly well-suited for use in the LiDAR applications, and in particular in the automotive industry. First, is the ability to improve optics of the article. Second is to not impact the aesthetics of the device or vehicle. Third is cost of the article.

Traditionally, multi-layer interference coatings have been applied to glass articles to provide LiDAR capabilities and anti-reflectiveness to glass articles. However, depositing multiple layers of coatings is time-consuming and costly.

### SUMMARY

A first aspect includes a laminated glass article comprising: a glass core layer; at least one glass cladding layer fused to the glass core layer, the at least one glass cladding layer having a porous region at an outer surface thereof, wherein the laminated glass article has a transmittance across an entire spectrum from about 875 nm to about 2000 nm that is greater than or equal to 97.0%, and the laminated glass article has a reflectance across an entire spectrum from 875 nm to 2000 nm that is less than or equal to 3.0%.

A second aspect includes the laminated glass article of the first aspect, wherein the laminated glass article has a transmittance across an entire visible spectrum that is greater than or equal to 97.0%.

A third aspect includes the laminated glass article of the first or second aspects, wherein the laminated glass article has a reflectance across an entire visible spectrum that is less than or equal to 1.5%.

A fourth aspect includes the laminated glass article of any one of the first to third aspects, wherein the laminated glass article has a transmittance across an entire spectrum from about 1200 nm to about 1800 nm that is greater than or equal to 97.5%, the laminated glass article has a reflectance across the entire spectrum from 900 nm to 2000 nm that is less than or equal to 2.0%, the laminated glass article has a transmittance across the entire visible spectrum that is greater than or equal to 99.5%, and the laminated glass article has a reflectance across the entire visible spectrum that is less than or equal to 1.0%.

A fifth aspect includes the laminated glass article of any one of the first to fourth aspects, wherein the laminated glass article has transmittance across an entire spectrum from 1500 nm to 1600 nm that is greater than 98%.

A sixth aspect includes the laminated glass article of any one of the first to fifth aspects, wherein the laminated glass article has a reflectance across an entire spectrum from 1500 nm to 1600 nm that is less than 0.8%.

A seventh aspect includes the laminated glass article of any one of the first to sixth aspects, wherein the porous region has an average pore size that is greater than or equal to 10 nm and less than or equal to 200 nm.

An eighth aspect includes the laminated glass article of any one of the first to seventh aspects, wherein the porous region has an average pore size that is greater than or equal to 20 nm and less than or equal to 150 nm.

A ninth aspect includes the laminated glass article of any one of the first to eighth aspects, wherein the porous region has a porosity that is greater than or equal 0.16 and less than or equal to 0.22.

A tenth aspect includes the laminated glass article of any one of the first to ninth aspects, wherein a thickness t of the porous region is:

$$t = \frac{n λ}{4}$$

where λ is the wavelength of LiDAR electromagnetic radiation from 905 nm to 1600 nm, and n is an odd number.

An eleventh aspect includes the laminated glass article of any one of the first to tenth aspects, wherein a thickness of the porous region is greater than or equal to 350 nm and less than or equal to 450 nm.

A twelfth aspect includes the laminated glass article of any one of the first to eleventh aspects, wherein a thickness of the porous region is greater than or equal to 375 nm and less than or equal to 400 nm.

A thirteenth aspect includes the laminated glass article of any one of the first to twelfth aspects, wherein the laminated glass article has a surface roughness that is less than or equal to 50 nm.

A fourteenth aspect includes a method for forming a laminated glass article comprising: obtaining a laminated glass article have a glass core layer and at least one cladding layer, wherein the at least one cladding layer is comprised of a phase-separable glass composition; heating the laminated glass article to form a phase-separated cladding layer having an interconnected matrix comprising a first phase and discrete dispersed regions comprising a second phase dispersed in the interconnected matrix; and etching the phase-separated cladding layer with an etching solution that etches away the discrete dispersed regions, thereby forming a porous region at a surface of the phase-separated cladding layer, wherein the laminated glass article has a transmittance across an entire spectrum from about 900 nm to about 2000 nm that is greater than or equal to 97.0%, and the laminated glass article has a reflectance across an entire spectrum from 900 nm to 2000 nm that is less than or equal to 3.0%.

A fifteenth aspect includes the method of the fourteenth aspect, wherein heating the laminated glass article comprises holding the laminated glass article at a temperature that is above a strain point of a glass that comprises the at least one cladding layer and that is below a softening point of the glass that comprises the at least one cladding layer for a time period that is greater than or equal to 1 minute and less than or equal to 24 hours.

A sixteenth aspect includes the method of the fourteenth and fifteenth aspects, wherein the laminated glass article is heated to a temperature that is greater than or equal to 500° C. and less than or equal to 1100° C.

A seventeenth aspect includes the method of any one of the fourteenth to sixteenth aspects, wherein etching the phase-separated cladding layer comprises etching the phase-separated cladding layer in an etching solution that comprises an acid in an amount greater than or equal to 0.5 vol. % and less than or equal to 10.0 vol. % for a time period that is greater than or equal to 60 seconds and less than or equal to 120 seconds.

An eighteenth aspect includes the method of the seventeenth aspect, wherein the acid is selected from the group consisting of hydrofluoric acid, hydrochloric acid, nitric acid, sulfuric acid, sodium hydroxide potassium hydroxide, buffered oxide etchants (BOEs), or combinations thereof.

A nineteenth aspect includes the method of any one of the fourteenth to eighteenth aspects, wherein heating the laminated glass article comprises holding the laminated glass article at a temperature that is above the strain point of the glass that comprises the at least one cladding layer and that is below the softening point of the glass that comprises the at least one cladding layer for a time period that is greater than or equal to 70 and less than or equal to 80 minutes, and etching the phase-separated cladding layer comprises etching the phase-separated cladding layer in an etching solution that comprises an acid in an amount greater than or equal to 1.5 vol. % and less than or equal to 2.0 vol. % for a time period that is greater than or equal to 80 seconds and less than or equal to 100 seconds.

A twentieth aspect includes the method of any one of the fourteenth to nineteenth aspects, wherein after etching the phase-separated cladding layer, the laminated glass article is submerged in a room temperature water bath for a time period that is greater than or equal to 5 seconds and less than or equal to 300 seconds.

Additional features and advantages will be set forth in the detailed description, which follows, and in part will be readily apparent to those skilled in the art from that description or recognized by practicing the embodiments described herein, including the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a schematic cross-section view of a laminated glass article according to embodiments disclosed and described herein;

FIG. 2 is a schematic cross-section view of a fusion draw apparatus according to embodiments disclosed and described herein;

FIG. 3 is a scanning electron microscope (SEM) image of a phase separated layer according to embodiments disclosed and described herein;

FIG. 4 is a schematic drawing of a phase separated cladding layer having a porous region according to embodiments disclosed and described herein;

FIG. 5 is a line graph showing the reflectance vs. wavelength of electromagnetic radiation for an uncoated glass article and a glass article coated with an MgF₂ coating;

FIG. 6A-6C are tunneling electron microscope (TEM) images of phase separated cladding layers of Comparative Example 1, Comparative Example 2, and Example 1;

FIG. 7 is a graph showing the transmittance vs. wavelength of electromagnetic radiation for Comparative Example 1, Comparative Example 2, and Example 1;

FIG. 8 is a graph showing the reflectance vs. wavelength of electromagnetic radiation for Comparative Example 1, Comparative Example 2, and Example 1;

FIG. 9 is a photograph of the laminated glass article according to Comparative Example 1; and

FIG. 10 is a photograph of the laminated glass article according to Example 1.

### DETAILED DESCRIPTION

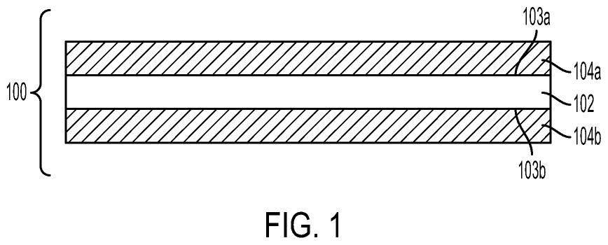

Reference will now be made in detail to embodiments of laminated glass articles having phase-separated glass cladding layers with a porous region and methods for making the same. FIG. 1 schematically depicts a cross section of one embodiment of a laminated glass article. The laminated glass article generally comprises a glass core layer and at least one glass cladding layer fused to the glass core layer. The at least one glass cladding layer is phase separated into a first phase and at least one second phase. Each of the phases have different compositions. The first phase forms an interconnected matrix in the glass cladding layer. The second phase is dispersed throughout the interconnected matrix of the first phase. In embodiments, the second phase may be removed from a portion of the at least one glass cladding layer such that the at least one glass cladding layer comprises a porous, interconnected matrix formed from the first phase at an outer surface of the at least one glass cladding layer. Various embodiments of such laminated glass articles and methods for making such laminated glass articles will be described in more detail herein with specific reference to the appended drawings.

The term “liquidus viscosity,” as used herein, refers to the shear viscosity of the glass composition at its liquidus temperature.

The term “liquidus temperature,” as used herein, refers to the highest temperature at which devitrification occurs in the glass composition.

The term “CTE,” as used herein, refers to the coefficient of thermal expansion of the glass composition averaged over a temperature range from about 20° C. to about 300° C.

The term “substantially free,” when used to describe the absence of a particular oxide component in a glass composition, means that the component is present in the glass composition as a contaminant in a trace amount of less than 1 mol. %.

In the embodiments of the glass compositions described herein, the concentration of constituent components (e.g., SiO₂, Al₂O₃, and the like) are given in mole percent (mol. %) on an oxide basis, unless otherwise specified.

Referring now to FIG. 1, a cross section of a laminated glass article is schematically depicted. The laminated glass article 100 generally comprises a glass core layer 102 and at least one glass cladding layer. In the embodiment depicted in FIG. 1, the laminated glass article includes a pair of glass cladding layers 104a, 104b. The glass core layer 102 generally comprises a first surface 103a and a second surface 103b that is opposed to the first surface 103a. In the embodiment depicted in FIG. 1, a first glass cladding layer 104a is fused to the first surface 103a of the glass core layer 102 and a second glass cladding layer 104b is fused to the second surface 103b of the glass core layer 102. The glass cladding layers 104a, 104b are fused to the glass core layer 102 without any additional materials, such as adhesives, coating layers or the like, disposed between the glass core layer 102 and the glass cladding layers 104a, 104b.

A variety of processes may be used to form the laminated glass articles described herein including, without limitation, the fusion lamination process, slot-draw lamination processes, and float glass processes.

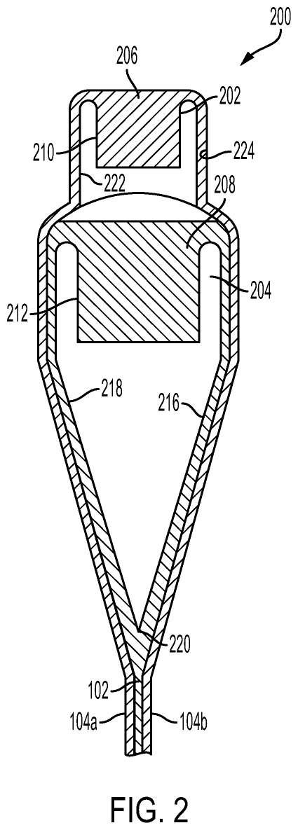

In embodiments, the laminated glass articles 100 may be formed by the fusion lamination process as described in U.S. Pat. No. 4,214,886, which is incorporated herein by reference. Referring to FIG. 2 by way of example, a laminate fusion draw apparatus 200 for forming a laminated glass article includes an upper isopipe 202 that is positioned over a lower isopipe 204. The upper isopipe 202 includes a trough 210 into which a phase-separable molten glass cladding composition 206 is fed from a melter (not shown). Similarly, the lower isopipe 204 includes a trough 212 into which a molten glass core composition 208 is fed from a melter (not shown).

As the molten glass core composition 208 fills the trough 212, it overflows the trough 212 and flows over the outer forming surfaces 216, 218 of the lower isopipe 204. The outer forming surfaces 216, 218 of the lower isopipe 204 converge at a root 220. Accordingly, the molten glass core composition 208 flowing over the outer forming surfaces 216, 218 rejoins at the root 220 of the lower isopipe 204 thereby forming a glass core layer 102 of a laminated glass article.

Simultaneously, the phase-separable molten glass cladding composition 206 overflows the trough 210 formed in the upper isopipe 202 and flows over outer forming surfaces 222, 224 of the upper isopipe 202. The phase-separable molten glass cladding composition 206 is outwardly deflected by the upper isopipe 202 such that the phase-separable molten glass cladding composition 206 flows around the lower isopipe 204 and contacts the molten glass core composition 208 flowing over the outer forming surfaces 216, 218 of the lower isopipe, fusing to the molten glass core composition and forming glass cladding layers 104a, 104b around the glass core layer 102.

In embodiments, the molten glass core composition 208 has an average coefficient of thermal expansion CTE_{core} that is greater than the average coefficient of thermal expansion CTE_{clad} of the phase-separable molten glass cladding composition 206. Accordingly, as the glass core layer 102 and the glass cladding layers 104a, 104b cool, the difference in the average coefficients of thermal expansion of the glass core layer 102 and the glass cladding layers 104a, 104b cause a compressive stresses to develop in the glass cladding layers 104a, 104b. The compressive stress increases the strength of the resulting laminated glass article without an ion-exchange treatment or thermal tempering treatment.

Once the glass cladding layers 104a, 104b have been fused to the glass core layer 102 thereby forming a laminated glass article 100, the laminated glass article may be optionally shaped into a desired three-dimensional form, such as by vacuum molding or any other conventional glass shaping process.

Once the laminated glass article 100 is formed by fusing the glass cladding layers 104a, 104b to the glass core layer 102 and optionally shaped, the laminated glass article 100 is heat treated to induce phase separation in the glass cladding layers 104a, 104b, thereby producing an interconnected matrix of a first phase in which at least one second phase is dispersed in the glass cladding layers 104a, 104b. The laminated glass article 100 is heated to a temperature that is above the strain point of the glass that comprises the glass cladding layers 104a, 104b and that is below the softening point of the glass that comprises the glass cladding layers 104a, 104b and holding the laminated glass article 100 at this temperature for a time period sufficient to induce the desired amount of phase separation in the glass cladding layers 104a, 104b. In view of this, the heat treatment of the laminated glass article 100 may occur at temperatures where the viscosity of the glass that forms the cladding layers 104a, 104b is less than 10¹⁴ poise (i.e., the viscosity at the strain point) and greater than 10^{7.8} poise (i.e., the viscosity at the softening point), such as less than or equal to 10¹² poise and greater than or equal to 10⁹ poise, or less than or equal to 10¹¹ pose and greater than or equal to 10¹⁰ poise. According to embodiments, the heat treatment process may include heating the laminated glass article to the upper consulate temperature or spinodal temperature of the phase-separable glass composition from which the glass cladding layers 104a, 104b are formed.

The laminated glass article 100 may be held at the heat treatment temperature for a time period sufficient to impart the desired amount of phase separation to the glass cladding layers 104a, 104b of the laminated glass article 100. In general, the longer the laminated glass article 100 is held at the heat treatment temperature, the greater the amount of phase separation that occurs in the glass cladding layers 104a, 104b of the laminated glass article.

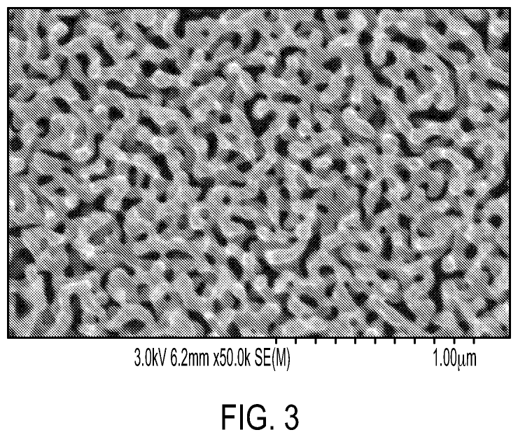

The heat treatment of the laminated glass article 100 is, in embodiments, utilized to disperse discrete regions of at least one second phase within an interconnected matrix formed from a first phase of the glass composition from which the glass cladding layers 104a, 104b are formed. FIG. 3 is a scanning electron microscope (SEM) image of this phase separation where an interconnected matrix is shown in lighter (grey) regions and the dispersed discrete regions are shown in darker (black) regions. In this embodiment, the size and amount of the dispersed discrete regions of the at least one secondary phase may be controlled by controlling the time and/or temperature of the heat treatment which, in turn, changes the optical properties of the resultant laminated glass article. For example, by controlling the size and amount of the dispersed discrete regions of the at least one second phase, the amount of light scattering which occurs within the laminated glass article 100 and/or the acoustic properties of the laminated glass article 100 may be controlled. For instance, in some embodiments, if the scale of the dispersed discrete regions are less than 150 nm to maintain desired optical properties of the laminated glass article 100. Scale is defined as the separation between the grey and the black regions disclosed above. Scale can be measured visually using SEM images, by image analysis, or by porosity when a porous region is formed. In embodiments, the scale of the dispersed discrete regions is less than or equal to 125 nm, less than or equal to 100 nm, less than or equal to 75 nm, or less than or equal to 50 nm. It has been found that every ten degrees Celsius increase in the treatment temperature doubles the rate at which the cladding layer will phase separate. Accordingly, control of the phase separation may be exerted by controlling the temperature at which the heat treatment occurs, and the hold time period may be modified depending on the temperature of the heat treatment. However, if the rate of phase separation is too high, it becomes difficult to control the amount of phase separation, and scale of the dispersed discrete regions can increase such that the optical properties of the laminated glass article 100 are diminished. Laminated glass articles 100 formed in this manner may be utilized in lighting applications, light filtration applications, and similar applications. Alternatively, laminated glass articles 100 formed in this manner may be utilized for building and automotive glazing.

In embodiments, the heat treatment time and temperature are selected such that, the at least one second phase is subsequently removed from the first phase, such that, for example, the interconnected matrix is comprised entirely or primarily of the first phase and the disperse discrete regions are comprised entirely or primarily of the second phase. More specifically, the time and temperature of the heat treatment may be selected such that a desired amount and distribution of the at least one second phase is present in the interconnected matrix of the first phase which, when removed from the interconnected matrix of the first phase, produces a desired index of refraction in the glass cladding layers 104a, 104b.

In embodiments, the heat treatment may be carried out at temperatures greater than or equal to 500° C. and less than or equal to 1100° C., such as greater than or equal to 550° C. and less than or equal to 1100° C., greater than or equal to 600° C. and less than or equal to 1100° C., greater than or equal to 650° C. and less than or equal to 1100° C., greater than or equal to 700° C. and less than or equal to 1100° C., greater than or equal to 750° C. and less than or equal to 1100° C., greater than or equal to 800° C. and less than or equal to 1100° C., greater than or equal to 850° C. and less than or equal to 1100° C., greater than or equal to 900° C. and less than or equal to 1100° C., greater than or equal to 950° C. and less than or equal to 1100° C., greater than or equal to 1000° C. and less than or equal to 1100° C., greater than or equal to 1050° C. and less than or equal to 1100° C., greater than or equal to 500° C. and less than or equal to 1050° C., greater than or equal to 550° C. and less than or equal to 1050° C., greater than or equal to 600° C. and less than or equal to 1050° C., greater than or equal to 650° C. and less than or equal to 1050° C., greater than or equal to 700° C. and less than or equal to 1050° C., greater than or equal to 750° C. and less than or equal to 1050° C., greater than or equal to 800° C. and less than or equal to 1050° C., greater than or equal to 850° C. and less than or equal to 1050° C., greater than or equal to 900° C. and less than or equal to 1050° C., greater than or equal to 950° C. and less than or equal to 1050° C., greater than or equal to 1000° C. and less than or equal to 1050° C., greater than or equal to 500° C. and less than or equal to 1000° C., greater than or equal to 550° C. and less than or equal to 1000° C., greater than or equal to 600° C. and less than or equal to 1000° C., greater than or equal to 650° C. and less than or equal to 1000° C., greater than or equal to 700° C. and less than or equal to 1000° C., greater than or equal to 750° C. and less than or equal to 1000° C., greater than or equal to 800° C. and less than or equal to 1000° C., greater than or equal to 850° C. and less than or equal to 1000° C., greater than or equal to 900° C. and less than or equal to 1000° C., greater than or equal to 950° C. and less than or equal to 1000° C., greater than or equal to 500° C. and less than or equal to 950° C., greater than or equal to 550° C. and less than or equal to 950° C., greater than or equal to 600° C. and less than or equal to 950° C., greater than or equal to 650° C. and less than or equal to 950° C., greater than or equal to 700° C. and less than or equal to 950° C., greater than or equal to 750° C. and less than or equal to 950° C., greater than or equal to 800° C. and less than or equal to 950° C., greater than or equal to 850° C. and less than or equal to 950° C., greater than or equal to 900° C. and less than or equal to 950° C., greater than or equal to 500° C. and less than or equal to 900° C., greater than or equal to 550° C. and less than or equal to 900° C., greater than or equal to 600° C. and less than or equal to 900° C., greater than or equal to 650° C. and less than or equal to 900° C., greater than or equal to 700° C. and less than or equal to 900° C., greater than or equal to 750° C. and less than or equal to 900° C., greater than or equal to 800° C. and less than or equal to 900° C., greater than or equal to 850° C. and less than or equal to 900° C., greater than or equal to 500° C. and less than or equal to 850° C., greater than or equal to 550° C. and less than or equal to 850° C., greater than or equal to 600° C. and less than or equal to 850° C., greater than or equal to 650° C. and less than or equal to 850° C., greater than or equal to 700° C. and less than or equal to 850° C., greater than or equal to 750° C. and less than or equal to 850° C., greater than or equal to 800° C. and less than or equal to 850° C., greater than or equal to 500° C. and less than or equal to 800° C., greater than or equal to 550° C. and less than or equal to 800° C., greater than or equal to 600° C. and less than or equal to 800° C., greater than or equal to 650° C. and less than or equal to 800° C., greater than or equal to 700° C. and less than or equal to 800° C., greater than or equal to 750° C. and less than or equal to 800° C., greater than or equal to 500° C. and less than or equal to 750° C., greater than or equal to 550° C. and less than or equal to 750° C., greater than or equal to 600° C. and less than or equal to 750° C., greater than or equal to 650° C. and less than or equal to 750° C., greater than or equal to 700° C. and less than or equal to 750° C., greater than or equal to 500° C. and less than or equal to 700° C., greater than or equal to 550° C. and less than or equal to 700° C., greater than or equal to 600° C. and less than or equal to 700° C., greater than or equal to 650° C. and less than or equal to 700° C., greater than or equal to 500° C. and less than or equal to 650° C., greater than or equal to 550° C. and less than or equal to 650° C., greater than or equal to 600° C. and less than or equal to 650° C., greater than or equal to 500° C. and less than or equal to 600° C., greater than or equal to 550° C. and less than or equal to 600° C., or greater than or equal to 500° C. and less than or equal to 550° C.

In embodiments, the laminated glass article 100 may be held at the heat treatment temperature for a time period greater than or equal to 1 minute and less than or equal to 24 hours. In embodiments, the laminated glass article 100 may be held at the heat treatment temperature for a time period greater than or equal to 15 minutes and less than or equal to 2 hours, greater than or equal to 25 minutes and less than or equal to 90 minutes, greater than or equal to 65 minutes and less than or equal to 85 minutes, greater than or equal to 70 minutes and less than or equal to 80 minutes, or about 75 minutes.

However, it should be understood that longer or shorter time periods may be used depending on the desired amount of phase separation in the glass cladding layers 104a, 104b.

In embodiments, the phase separated glass of the glass cladding layers 104a, 104b may be a spinodal phase separated glass (i.e., the glass cladding layers are formed from a glass composition that is susceptible to spinodal decomposition). In these embodiments the glass cladding layers 104a, 104b include an interconnected matrix of glass formed from the first phase with the second phase dispersed throughout the interconnected matrix of the first phase. However, in these embodiments, the second phase is itself interconnected within the interconnected matrix of the first phase. In these embodiments, the first phase and the at least one second phase may have different dissolution rates in water, alkaline solutions, and/or acidic solutions. For example, the at least one second phase present in the phase separated glass cladding layers 104a, 104b may more readily dissolve in water and/or acidic solutions than the first phase. Alternatively, the first phase present in the phase separated glass cladding layers 104a, 104b may more readily dissolve in water and/or acidic solutions than the at least one second phase. This characteristic enables either first phase or the second phase to be selectively removed from the glass cladding layers 104a, 104b such that the glass cladding layers 104a, 104b have a porous region near an outer surface.

Following the heat treatment that induces phase separation in the glass cladding layers 104a, 104b, the laminated glass article 100 is further processed to remove the at least one second phase in the disperse discrete regions from the interconnected matrix of the first phase of the glass cladding layers 104a, 104b, which will form a porous, interconnected matrix of the first phase in the glass cladding layers 104a, 104b. To achieve this porous, interconnected matrix, the at least one second phase may be removed from the interconnected matrix of the first phase by etching the laminated glass article. As an example, where the cladding layers 104a, 104b are formed from a high boron content alumino-silicate glass composition, the heat treatment will result in a silicon-rich interconnected matrix and boron-rich disperse discrete regions. The boron-rich disperse discrete regions are more susceptible to begin etched away with weak acidic acids. A variety of etchants or combinations of etchants may be used including, without limitation, hydrofluoric acid, hydrochloric acid, nitric acid, sulfuric acid, sodium hydroxide potassium hydroxide, buffered oxide etchants (BOEs), or combinations thereof.

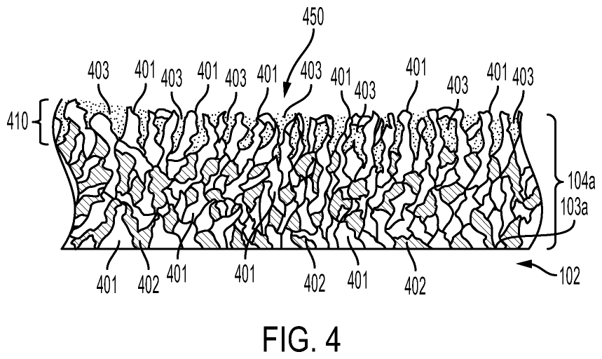

The strength of the acid and the time period of the etching treatment can be controlled such only a portion of the phase separated cladding layers 104a, 104b is converted into a porous region that is devoid of second phase disperse discrete regions. With reference now to FIG. 4, cladding layer 104a is shown after an etching treatment has been conducted. Near the surface 103a of the core layer 102 the cladding layer 104a comprises an interconnected matrix 401 (white portions) formed from a first phase and disperse discrete regions 402 (dark portions) formed from a second phase. At the surface of the cladding layer 104a opposite the surface 103a of the core layer 102, the second phase of the disperse discrete regions have been removed, such as via etching, to provide a porous region 410 that comprises an interconnected matrix 401 formed from the first phase and porous regions 403 (indicated with dotting). Accordingly, the porous region 410 has a thickness that can be measured from the exposed surface 450 of the cladding layer 104a toward the surface 103a of the core layer 102. The thickness of the porous layer 410 may be controlled by using more or less concentrated acidic etching solution, using a stronger or weaker acid, and by modifying the time period of the etching treatment.

In embodiments, an acid, such as hydrofluoric acid (HF), is used in the etching solution. In such embodiments, the acid, such as HF, is present in the etching solution in amounts greater than or equal to 0.5 volume percent (vol. %) and less than or equal to 10.0 vol. %, such as greater than or equal to 1.0 vol. % and less than or equal to 10.0 vol. %, greater than or equal to 2.0 vol. % and less than or equal to 10.0 vol. %, greater than or equal to 3.0 vol. % and less than or equal to 10.0 vol. %, greater than or equal to 4.0 vol. % and less than or equal to 10.0 vol. %, greater than or equal to 5.0 vol. % and less than or equal to 10.0 vol. %, greater than or equal to 6.0 vol. % and less than or equal to 10.0 vol. %, greater than or equal to 7.0 vol. % and less than or equal to 10.0 vol. %, greater than or equal to 8.0 vol. % and less than or equal to 10.0 vol. %, greater than or equal to 9.0 vol. % and less than or equal to 10.0 vol. %, greater than or equal to 0.5 vol. % and less than or equal to 9.0 vol. %, greater than or equal to 1.0 vol. % and less than or equal to 9.0 vol. %, greater than or equal to 2.0 vol. % and less than or equal to 9.0 vol. %, greater than or equal to 3.0 vol. % and less than or equal to 9.0 vol. %, greater than or equal to 4.0 vol. % and less than or equal to 9.0 vol. %, greater than or equal to 5.0 vol. % and less than or equal to 9.0 vol. %, greater than or equal to 6.0 vol. % and less than or equal to 9.0 vol. %, greater than or equal to 7.0 vol. % and less than or equal to 9.0 vol. %, greater than or equal to 8.0 vol. % and less than or equal to 9.0 vol. %, greater than or equal to 0.5 vol. % and less than or equal to 8.0 vol. %, greater than or equal to 1.0 vol. % and less than or equal to 8.0 vol. %, greater than or equal to 2.0 vol. % and less than or equal to 8.0 vol. %, greater than or equal to 3.0 vol. % and less than or equal to 8.0 vol. %, greater than or equal to 4.0 vol. % and less than or equal to 8.0 vol. %, greater than or equal to 5.0 vol. % and less than or equal to 8.0 vol. %, greater than or equal to 6.0 vol. % and less than or equal to 8.0 vol. %, greater than or equal to 7.0 vol. % and less than or equal to 8.0 vol. %, greater than or equal to 0.5 vol. % and less than or equal to 7.0 vol. %, greater than or equal to 1.0 vol. % and less than or equal to 7.0 vol. %, greater than or equal to 2.0 vol. % and less than or equal to 7.0 vol. %, greater than or equal to 3.0 vol. % and less than or equal to 7.0 vol. %, greater than or equal to 4.0 vol. % and less than or equal to 7.0 vol. %, greater than or equal to 5.0 vol. % and less than or equal to 7.0 vol. %, greater than or equal to 6.0 vol. % and less than or equal to 7.0 vol. %, greater than or equal to 0.5 vol. % and less than or equal to 6.0 vol. %, greater than or equal to 1.0 vol. % and less than or equal to 6.0 vol. %, greater than or equal to 2.0 vol. % and less than or equal to 6.0 vol. %, greater than or equal to 3.0 vol. % and less than or equal to 6.0 vol. %, greater than or equal to 4.0 vol. % and less than or equal to 6.0 vol. %, greater than or equal to 5.0 vol. % and less than or equal to 6.0 vol. %, greater than or equal to 0.5 vol. % and less than or equal to 5.0 vol. %, greater than or equal to 1.0 vol. % and less than or equal to 5.0 vol. %, greater than or equal to 2.0 vol. % and less than or equal to 5.0 vol. %, greater than or equal to 3.0 vol. % and less than or equal to 5.0 vol. %, greater than or equal to 4.0 vol. % and less than or equal to 5.0 vol. %, greater than or equal to 0.5 vol. % and less than or equal to 4.0 vol. %, greater than or equal to 1.0 vol. % and less than or equal to 4.0 vol. %, greater than or equal to 2.0 vol. % and less than or equal to 4.0 vol. %, greater than or equal to 3.0 vol. % and less than or equal to 4.0 vol. %, greater than or equal to 0.5 vol. % and less than or equal to 3.0 vol. %, greater than or equal to 1.0 vol. % and less than or equal to 3.0 vol. %, greater than or equal to 2.0 vol. % and less than or equal to 3.0 vol. %, greater than or equal to 0.5 vol. % and less than or equal to 2.0 vol. %, greater than or equal to 1.0 vol. % and less than or equal to 2.0 vol. %, or greater than or equal to 0.5 vol. % and less than or equal to 1.0 vol. %.

The time period of the etching, according to embodiments, is greater than or equal to 5 seconds and less than or equal to 3600 seconds, such as greater than or equal to 60 seconds and less than or equal to 3540 seconds, greater than or equal to 120 seconds and less than or equal to 3480 seconds, greater than or equal to 180 seconds and less than or equal to 3420 seconds, greater than or equal to 240 seconds and less than or equal to 3360 seconds, greater than or equal to 300 seconds and less than or equal to 3300 seconds, greater than or equal to 360 seconds and less than or equal to 3240 seconds, greater than or equal to 420 seconds and less than or equal to 3180 seconds, greater than or equal to 480 seconds and less than or equal to 3120 seconds, greater than or equal to 540 seconds and less than or equal to 3060 seconds, greater than or equal to 600 seconds and less than or equal to 3000 seconds, greater than or equal to 660 seconds and less than or equal to 2040 seconds, greater than or equal to 720 seconds and less than or equal to 1080 seconds, greater than or equal to 780 seconds and less than or equal to 1020 seconds, greater than or equal to 840 seconds and less than or equal to 960 seconds, or about 90 seconds.

After the etching treatment is complete, the laminated glass article may, according to embodiments, be submerged in a room temperature water bath for a time period that is greater than or equal to 5 seconds and less than or equal to 300 seconds, such as greater than or equal to 20 seconds and less than or equal to 250 seconds, greater than or equal to 30 seconds and less than or equal to 225 seconds, greater than or equal to 40 seconds and less than or equal to 200 seconds, greater than or equal to 50 seconds and less than or equal to 150 seconds, greater than or equal to 90 seconds and less than or equal to 150 seconds, greater than or equal to 120 seconds and less than or equal to 140 seconds.

The heat treatment and the etching treatment described above can be modified to achieved desired physical properties of the porous region, such as average pore size, porosity, and packing density. These physical properties in turn have an effect on the transmittance and reflectance of the laminated glass article. These properties will now be described.

The porous region 410 described herein has antireflective properties that is effected, in part, from average pore size of the porous region. Accordingly, in embodiments the average pore size of the porous region 410 is greater than or equal to 10 nm and less than or equal to 200 nm, such as greater than or equal to 25 nm and less than or equal to 200 nm, greater than or equal to 50 nm and less than or equal to 200 nm, greater than or equal to 75 nm and less than or equal to 200 nm, greater than or equal to 100 nm and less than or equal to 200 nm, greater than or equal to 125 nm and less than or equal to 200 nm, greater than or equal to 150 nm and less than or equal to 200 nm, greater than or equal to 175 nm and less than or equal to 200 nm, greater than or equal to 10 nm and less than or equal to 175 nm, greater than or equal to 25 nm and less than or equal to 175 nm, greater than or equal to 50 nm and less than or equal to 175 nm, greater than or equal to 75 nm and less than or equal to 175 nm, greater than or equal to 100 nm and less than or equal to 175 nm, greater than or equal to 125 nm and less than or equal to 175 nm, greater than or equal to 150 nm and less than or equal to 175 nm, greater than or equal to 10 nm and less than or equal to 150 nm, greater than or equal to 25 nm and less than or equal to 150 nm, greater than or equal to 50 nm and less than or equal to 150 nm, greater than or equal to 75 nm and less than or equal to 150 nm, greater than or equal to 100 nm and less than or equal to 150 nm, greater than or equal to 125 nm and less than or equal to 150 nm, greater than or equal to 10 nm and less than or equal to 125 nm, greater than or equal to 25 nm and less than or equal to 125 nm, greater than or equal to 50 nm and less than or equal to 125 nm, greater than or equal to 75 nm and less than or equal to 125 nm, greater than or equal to 100 nm and less than or equal to 125 nm, greater than or equal to 10 nm and less than or equal to 100 nm, greater than or equal to 25 nm and less than or equal to 100 nm, greater than or equal to 50 nm and less than or equal to 100 nm, greater than or equal to 75 nm and less than or equal to 100 nm, greater than or equal to 10 nm and less than or equal to 75 nm, greater than or equal to 25 nm and less than or equal to 75 nm, greater than or equal to 50 nm and less than or equal to 75 nm, greater than or equal to 10 nm and less than or equal to 50 nm, greater than or equal to 25 nm and less than or equal to 50 nm, or greater than or equal to 10 nm and less than or equal to 25 nm. The average pore size is measure by porisometry or image analysis using an SEM image or the like.

The refractivity of the laminated glass article 100 is also affected by the packing density. In embodiments, the packing density is greater than or equal to 20% and less than or equal to 40%, such as greater than or equal to 22% and less than or equal to 40%, greater than or equal to 25% and less than or equal to 40%, greater than or equal to 28% and less than or equal to 40%, greater than or equal to 30% and less than or equal to 40%, greater than or equal to 32% and less than or equal to 40%, greater than or equal to 35% and less than or equal to 40%, greater than or equal to 38% and less than or equal to 40%, greater than or equal to 20% and less than or equal to 38%, greater than or equal to 20% and less than or equal to 35%, greater than or equal to 20% and less than or equal to 32%, greater than or equal to 20% and less than or equal to 30%, greater than or equal to 20% and less than or equal to 28%, greater than or equal to 20% and less than or equal to 25%, greater than or equal to 22% and less than or equal to 40%, greater than or equal to 25% and less than or equal to 35%, greater than or equal to 28% and less than or equal to 32%, or about 30%. Packing density is measured by image analysis using SEM images or the like.

The average pore size and porosity of the porous region 410 may be altered by controlling the heat treatment through which phase separation occurs and the etching treatment by which a second phase is removed from discrete dispersed regions. In addition, using a strong etchant, or etching for an extended period of time may also slightly increase the pore size. The average pore size and porosity of the porous layer 410 may, in embodiments, effect the reflectance and refraction of light of the laminated glass article 100, thereby providing an anti-reflective and/or refractive effect on the laminated glass article 100.

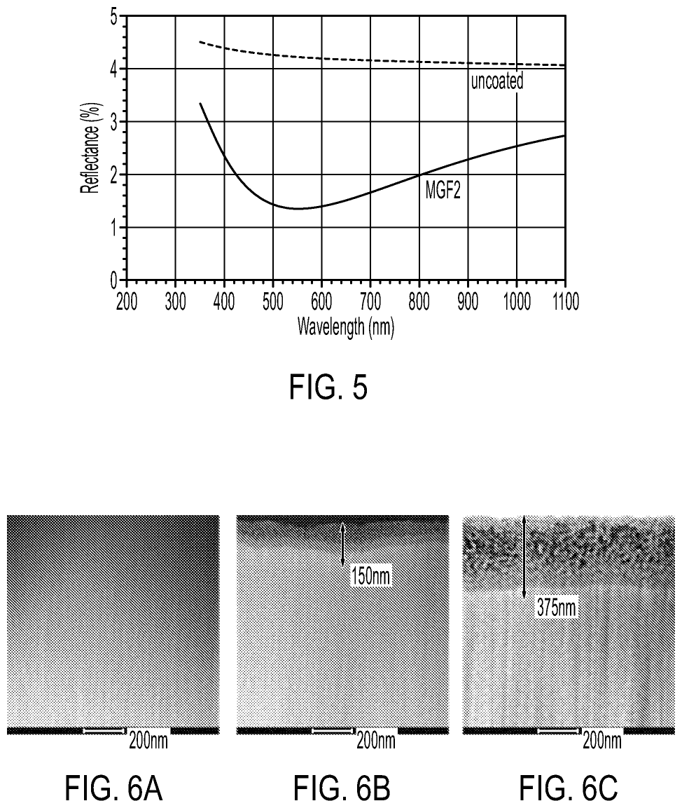

Although porous surfaces have been introduced to glass articles to reduce reflection across the visible electromagnetic spectrum (i.e., from about 400 nm to about 700); heretofore, porous surfaces have not been evaluated for their reflective effect beyond the visible electromagnetic spectrum. Without being bound by any particular theory, and with reference to FIG. 5, this is likely because traditional interference coatings tend to have relatively localized, U-shaped reflectance curves. As an example, FIG. 5 shows that the reflectance of an uncoated glass article is from about 4.4% at a wavelength of 400 nm and gradually decreases to a reflectance of about 4.0% at a wavelength of 1100 nm. FIG. 5 also shows that the same glass article treated with an MgF₂ antireflective coating has a reflectance of about 2.2% at a wavelength of about 400 nm that rapidly decreases to a minimum reflectance of about 1.4% at a wavelength of about 550 nm and gradually increases to a reflectance of about 3.6% at a wavelength of 1100 nm. The U-shaped curve in FIG. 5 shows reflectance performance common to conventional interference coatings (such as, for example, MgF₂) that has a maximum transmission (or minimum reflectance) based on the quarter wavelength (nλ/4) where X is the wavelength of incident light and n is the refractive index of the material. As shown in FIG. 5, these conventional interference films work over a narrow range of the wavelength spectrum centered on a minimum reflectance at the quarter wave. Using this information, a conventional interference film that has low reflectance in the visible spectrum of electromagnetic radiation (such as the MgF₂ film in FIG. 5) would have a relatively high reflectance at LiDAR wavelengths (around 1550 nm) due to the U-shape of the reflectance curve, and interference films with a quarter wave focused around LiDAR wavelengths would be expected to have poor anti-reflective properties in the visible spectrum. Previously, it was believed that antireflective porous layers would have U-shaped reflectance curves similar to interference coatings as described above and as shown in FIG. 5. However, the present disclosure shows that this is not the case.

Controlling the thickness of the porous region in a laminated glass article, such as by controlling the heat treatment and etching treatment as discussed above, to have a thickness of about 400 nm (i.e., roughly the quarter wavelength thickness for 1550 nm LiDAR wavelengths) was found to not only reduce the reflectance at LiDAR wavelengths, but also resulted in reduced reflectance across the visible spectrum. This is advantageous in that laminated glass articles according to embodiments disclosed and described herein have low reflectance (and therefore high transmission) of both visible light and LiDAR electromagnetic radiation.

The thickness of the porous region may, according to embodiments, be measured using the quarter wave equation, where the thickness of the porous region meets the following equation:

$$t = \frac{n λ}{4}$$

where t is the thickness, λ is the wavelength of LiDAR electromagnetic radiation from 950 nm to 1600 nm, and n is an odd number (1, 3, 5, 7, 9, 11, . . . ).

In embodiments, porous regions with a thickness greater than or equal to 350 nm and less than or equal to 450 nm showed the above-described reflective effects, such as porous regions with a thickness greater than or equal to 360 nm and less than or equal to 450 nm, greater than or equal to 370 nm and less than or equal to 450 nm, greater than or equal to 380 nm and less than or equal to 450 nm, greater than or equal to 390 nm and less than or equal to 450 nm, greater than or equal to 400 nm and less than or equal to 450 nm, greater than or equal to 410 nm and less than or equal to 450 nm, greater than or equal to 420 nm and less than or equal to 450 nm, greater than or equal to 430 nm and less than or equal to 450 nm, greater than or equal to 440 nm and less than or equal to 450 nm, greater than or equal to 350 nm and less than or equal to 440 nm, greater than or equal to 350 nm and less than or equal to 430 nm, greater than or equal to 350 nm and less than or equal to 420 nm, greater than or equal to 350 nm and less than or equal to 410 nm, greater than or equal to 350 nm and less than or equal to 400 nm, greater than or equal to 350 nm and less than or equal to 390 nm, greater than or equal to 350 nm and less than or equal to 380 nm, greater than or equal to 350 nm and less than or equal to 370 nm, or greater than or equal to 350 nm and less than or equal to 360 nm. The thickness of the porous portion was measured visually using an SEM.

Laminated glass articles according to embodiments disclosed and described herein have transmittance across the entire visible spectrum that is greater than or equal to 97.0%, such as greater than or equal to 97.2%, greater than or equal to 97.5%, greater than or equal to 97.8%, greater than or equal to 98.0%, greater than or equal to 98.2%, greater than or equal to 98.5%, greater than or equal to 98.8%, greater than or equal to 99.0%, greater than or equal to 99.2%, or greater than or equal to 99.5%. Transmittance is measured using a spectrophotometer having an integrating sphere. The measurement is of the total, which includes both diffuse and specular transmittance. Transmittance is measured using an X-Rite Ci7860 Benchtop Spectrophotometer. Laminated glass articles according to embodiments disclosed and described herein have a transmittance across the entire spectrum from 400 nm to 600 nm that is greater than or equal to 99.0%, such as greater than or equal to 99.2%, greater than or equal to 99.5%, or greater than or equal to 99.8%. Laminated glass articles according to embodiments disclosed and described herein have a transmittance across the entire spectrum from 600 nm to 800 nm that is greater than or equal to 99.0%, such as greater than or equal to 99.2%, greater than or equal to 99.5%, or greater than or equal to 99.8%. As used herein, “across the entire . . . spectrum” or “across the spectrum from . . . ” means that any minimum transmittance in the stated spectrum is not below the stated value.

Laminated glass articles according to embodiments disclosed and described herein also have transmittance across the entire spectrum from about 900 nm to about 2000 nm that is greater than or equal to 97.0%, such as greater than or equal to 97.2%, greater than or equal to 97.5%, greater than or equal to 97.8%, greater than or equal to 98.0%, greater than or equal to 98.2%, greater than or equal to 98.5%, greater than or equal to 98.8%, or greater than or equal to 99.0%. Laminated glass articles according to embodiments disclosed and described herein also have transmittance across the entire spectrum from about 1200 nm to about 1800 nm that is greater than or equal to 97.5%, such as greater than or equal to 97.8%, greater than or equal to 98.0%, greater than or equal to 98.2%, greater than or equal to 98.5%, greater than or equal to 98.8%, or greater than or equal to 99.0%. Laminated glass articles according to embodiments disclosed and described herein also have transmittance across the entire LiDAR spectrum (i.e., from about 1500 to about 1600) that is greater than or equal to 97.5%, greater than or equal to 97.8%, greater than or equal to 98.0%, greater than or equal to 98.2%, greater than or equal to 98.5%, greater than or equal to 98.8%, or greater than or equal to 99.0%.

Laminated glass articles according to embodiments disclosed and described herein, and including two clad layers 104a, 104b as shown in FIG. 1, have reflectance across the entire visible spectrum that is less than or equal to 1.5%, such as less than or equal to 1.2%, less than or equal to 1.0%, less than or equal to 0.8%, or less than or equal to 0.5%. The reflectance is measured by a X-Rite Ci7860 Benchtop Spectrophotometer on a glass article having a core that is 0.56 mm thick and a clad that is 70 μm thick. Laminated glass articles according to embodiments disclosed and described herein have a reflectance across the entire spectrum from 400 nm to 600 nm that is less than or equal to 0.8%, such as less than or equal to 0.5%, or less than or equal to 0.2%. Laminated glass articles according to embodiments disclosed and described herein have a reflectance across the entire spectrum from 600 nm to 800 nm that is less than or equal to 1.5%, such as less than or equal to 1.2%, or less than or equal to 1.0%.

Laminated glass articles according to embodiments disclosed and described herein also have reflectance across the entire spectrum from about 900 nm to about 2000 nm that is less than or equal to 3.0%, such as less than or equal to 2.8%, less than or equal to 2.5%, less than or equal to 2.2%, less than or equal to 2.0%, less than or equal to 1.8%, less than or equal to 1.5%, or less than or equal to 1.2%. Laminated glass articles according to embodiments disclosed and described herein also have reflectance across the entire spectrum from about 1200 nm to about 1800 nm that is less than or equal to 1.8%, such as less than or equal to 1.5%, less than or equal to 1.2%, or less than or equal to 1.0%. Laminated glass articles according to embodiments disclosed and described herein also have reflectance across the entire LiDAR spectrum (i.e., from about 1500 to about 1600) that is less than or equal to 1.0%, less than or equal to 0.8%, or less than or equal to 0.5%.

It should be understood that the reflectance and transmittance in the visible spectrum detailed above and the reflectance and transmittance at IR wavelengths-including LiDAR wavelength-detailed above coexist. Accordingly, laminated glass articles according to embodiments disclosed and described herein unexpectedly do not have the U-shaped curve of conventional interference films. Instead, laminated glass articles according to embodiments disclosed and described herein provide improved transmittance and reflectance across both the visible and IR wavelengths, including LiDAR wavelengths. This allows the laminated glass articles according to embodiments disclosed and described herein to provide good optical performance in the visible spectrum while also transmitting LiDAR wavelength electromagnetic radiation that is increasingly being used to convey information or detect the presence of an object, as described above.

In embodiments, the laminated glass article may have a surface roughness that is less than or equal to 50 nm, such as less than or equal to 45 nm, less than or equal to 40 nm, less than or equal to 35 nm, less than or equal to 30 nm, less than or equal to 25 nm, less than or equal to 20 nm, less than or equal to 15 nm, or less than or equal to 10 nm. As measured by atomic force microscopy or a Zygo optical profiler. In one or more embodiments, the laminated glass article has a surface roughness that is greater than or equal to 10 nm and less than or equal to 50 nm, such as greater than or equal to 15 nm and less than or equal to 50 nm, greater than or equal to 20 nm and less than or equal to 50 nm, greater than or equal to 25 nm and less than or equal to 50 nm, greater than or equal to 30 nm and less than or equal to 50 nm, greater than or equal to 35 nm and less than or equal to 50 nm, greater than or equal to 40 nm and less than or equal to 50 nm, greater than or equal to 45 nm and less than or equal to 50 nm, greater than or equal to 10 nm and less than or equal to 45 nm, greater than or equal to 15 nm and less than or equal to 45 nm, greater than or equal to 20 nm and less than or equal to 45 nm, greater than or equal to 25 nm and less than or equal to 45 nm, greater than or equal to 30 nm and less than or equal to 45 nm, greater than or equal to 35 nm and less than or equal to 45 nm, greater than or equal to 40 nm and less than or equal to 45 nm, greater than or equal to 10 nm and less than or equal to 40 nm, greater than or equal to 15 nm and less than or equal to 40 nm, greater than or equal to 20 nm and less than or equal to 40 nm, greater than or equal to 25 nm and less than or equal to 40 nm, greater than or equal to 30 nm and less than or equal to 40 nm, greater than or equal to 35 nm and less than or equal to 40 nm, greater than or equal to 10 nm and less than or equal to 35 nm, greater than or equal to 15 nm and less than or equal to 35 nm, greater than or equal to 20 nm and less than or equal to 35 nm, greater than or equal to 25 nm and less than or equal to 35 nm, greater than or equal to 30 nm and less than or equal to 35 nm, greater than or equal to 10 nm and less than or equal to 30 nm, greater than or equal to 15 nm and less than or equal to 30 nm, greater than or equal to 20 nm and less than or equal to 30 nm, greater than or equal to 25 nm and less than or equal to 30 nm, greater than or equal to 10 nm and less than or equal to 25 nm, greater than or equal to 15 nm and less than or equal to 25 nm, greater than or equal to 20 nm and less than or equal to 25 nm, greater than or equal to 10 nm and less than or equal to 20 nm, greater than or equal to 15 nm and less than or equal to 20 nm, or greater than or equal to 10 nm and less than or equal to 15 nm.

In the embodiments of the laminated glass articles described herein, the glass cladding layers 104a, 104b are phase separated into a first glass phase and at least one second glass phase with each of the glass phases having different compositions. Accordingly, it should be understood that the glass cladding layers 104a, 104b are formed from a glass composition which is susceptible to phase separation upon exposure to a phase separation treatment (i.e., the glass composition is a “phase-separable” glass composition). The phrase “phase-separable” glass composition, as used herein, refers to a glass composition, which undergoes phase separation into two or more distinct phases upon exposure to a phase separation treatment, such as a heat treatment or the like. In one embodiment, the glass cladding layers are formed from the glass composition disclosed in U.S. Pat. Nos. 9,527,767 and 9,764,981, which are incorporated herein by reference in their entireties. In this embodiment, the glass composition comprises a combination of SiO₂, Al₂O₃, B₂O₃, and alkaline earth oxides. It has now been found that this glass readily undergoes phase separation upon heat treatment below the spinodal temperature.

In the aforementioned exemplary clad glass composition, SiO₂ is the largest constituent and, as such, SiO₂ is the primary constituent of the glass network formed from the clad glass composition. Pure SiO₂ has a relatively low CTE and is alkali free. However, pure SiO₂ has an extremely high melting point. Accordingly, if the concentration of SiO₂ in the clad glass composition is too high, the formability of the clad glass composition may be diminished as higher concentrations of SiO₂ increase the difficulty of melting the glass that, in turn, adversely impacts the formability of the glass. In this embodiment, the clad glass composition generally comprises SiO₂ in a concentration less than or equal to about 66 mol. % in order to facilitate fusion forming the clad glass composition. For example, in some embodiments, the concentration of SiO₂ in the clad glass composition is greater than or equal to about 60 mol. % and less than or equal to about 66 mol. %. In some other embodiments, SiO₂ is present in the clad glass composition in a concentration greater than or equal to about 63 mol. % and less than or equal to about 65 mol. %.

The clad glass composition of embodiments further comprises Al₂O₃. Al₂O₃ serves as a glass network former, similar to SiO₂. Like SiO₂, Al₂O₃ increases the viscosity of the clad glass composition due to its tetrahedral coordination in a glass melt formed from the clad glass composition. However, when the concentration of Al₂O₃ is balanced against the concentration of SiO₂ and the concentration of alkaline earth oxides in the clad glass composition, Al₂O₃ can reduce the liquidus temperature of the glass melt, thereby enhancing the liquidus viscosity and improving the compatibility of the clad glass composition with certain forming processes such as the fusion forming process.

The concentration of Al₂O₃ in the clad glass composition is generally less than or equal to about 10 mol. % in order to achieve the desired liquidus temperature to facilitate formation of the laminated glass article using fusion forming techniques. For example, in some embodiments, the concentration of Al₂O₃ in the clad glass composition is greater than or equal to about 6 mol. % and less than or equal to about 10 mol. %. In some of these embodiments, the concentration of Al₂O₃ in the clad glass composition may be less than or equal to about 9 mol. % or even less than or equal to about 8 mol. %. For example, in some embodiments, the concentration of Al₂O₃ in the clad glass composition is greater than or equal to about 7 mol. % and less than or equal to about 9 mol. % or even greater than or equal to about 7 mol. % and less than or equal to about 8 mol. %.

The clad glass composition of embodiments may further comprise B₂O₃. Like SiO₂ and Al₂O₃, B₂O₃ contributes to the formation of the glass network. B₂O₃ is added to the clad glass composition to decrease the viscosity and liquidus temperature of the glass. Specifically, an increase in the concentration of B₂O₃ by 1 mol. % may decrease the temperature required to obtain an equivalent viscosity by 10° C. to 14° C., depending on the specific composition of the glass. However, B₂O₃ can lower the liquidus temperature of a clad glass composition by 18° C. to 22° C. per mol. % of B₂O₃. As such, B₂O₃ decreases the liquidus temperature of the clad glass composition more rapidly than it decreases the liquidus viscosity of the clad glass composition. B₂O₃ is also added to the clad glass composition to soften the glass network. Moreover, when the clad glass composition is used for glass cladding layers in a fusion formed laminated glass article, the B₂O₃ in the glass cladding layers is utilized to match the viscosity of the glass cladding layers to that of the glass core layer, particularly when the glass core layer is an alkali-containing glass core layer. Further, additions of B₂O₃ to the clad glass composition also reduce the Young's modulus of the clad glass composition and improve the intrinsic damage resistance of the glass. In addition, the incorporation of B₂O₃ in the clad glass composition also facilitates phase separating the clad glass composition into a silica-rich phase and a boron-rich phase. In these embodiments, the silica-rich phase may be less susceptible to dissolution in water and/or an acidic solution than the boron-rich phase that, in turn, facilitates the selective removal of the boron-rich phase and the formation of a porous microstructure in the glass cladding layers.

In embodiments, B₂O₃ is generally present in the clad glass composition in a concentration greater than or equal to about 14 mol. %. For example, in some embodiments, B₂O₃ is present in the clad glass composition in a concentration greater than or equal to about 14 mol. % and less than or equal to about 18 mol. %. In some of these embodiments, the concentration of B₂O₃ in the clad glass composition may be less than or equal to about 17 mol. % or even less than or equal to about 16 mol. %. In other embodiments described herein, B₂O₃ is present in the clad glass composition in a concentration greater than or equal to about 16 mol. % and less than or equal to about 17 mol. %.

Embodiment of the clad glass composition used for the glass cladding layers may also include at least one alkaline earth oxide. The alkaline earth oxide generally improves the melting behavior of the clad glass composition by lowering the temperature required for melting. Moreover, a combination of several different alkaline earth oxides assists in lowering the liquidus temperature of the clad glass composition and increasing the liquidus viscosity of the clad glass composition. The alkaline earth oxides included in the clad glass composition are CaO, MgO, SrO and/or combinations thereof.

The alkaline earth oxide is present in the clad glass composition in a concentration greater than or equal to about 9 mol. % and less than or equal to about 16 mol. %. In some embodiments, the clad glass composition may comprise from about 11 mol. % to about 12 mol. % alkaline earth oxide. The clad glass composition includes at least CaO as an alkaline earth oxide in a concentration greater than or equal to about 3 mol. % and less than or equal to about 12 mol. %. In some embodiments, the concentration of CaO may be greater than or equal to about 7 mol. % and less than or equal to about 12 mol. %. The alkaline earth oxide may further include MgO in a concentration greater than or equal to about 0 mol. % and less than or equal to about 6 mol. %. In some embodiments the concentration of MgO in the clad glass composition may be greater than or equal to about 2 mol. % and less than or equal to about 4 mol. %. The alkaline earth oxide in the clad glass composition may also include SrO in a concentration greater than or equal to about 0 mol. % and less than or equal 6 mol. %. In some embodiments, the SrO may be present in the clad glass composition in a concentration from about 1 mol. % to about 4 mol. %.

Embodiments of the clad glass composition used for forming the glass cladding layers of the laminate glass article may be substantially free from alkali metals and compounds containing alkali metals. Accordingly, it should be understood that the clad glass composition is substantially free from alkali oxides such as K₂O, Na₂O and Li₂O.

The clad glass composition of embodiments may optionally include one or more fining agents. The fining agents may include, for example, SnO₂, As₂O₃, Sb₂O₃ and combinations thereof. The fining agents may be present in the clad glass composition in an amount greater than or equal to about 0 mol. % and less than or equal to about 0.5 mol. %. In exemplary embodiments, the fining agent is SnO₂. In these embodiments, SnO₂ may be present in the clad glass composition in a concentration which is greater than about 0 mol. % and less than or equal to about 0.2 mol. % or even less than or equal to about 0.15 mol. %.

Accordingly, and with reference again to FIG. 1, in embodiments, the glass cladding layers 104a, 104b may be formed from a clad glass composition which includes from about 60 mol. % to about 66 mol. % SiO₂; from about 6 mol. % to about 10 mol. % Al₂O₃; and from about 14 mol. % to about 18 mol. % B₂O₃ as glass network formers. The clad glass composition from which the glass cladding layers are formed may further include from about 9 mol. % to about 16 mol. % alkaline earth oxide. The alkaline earth oxide includes at least CaO. The CaO may be present in the clad glass composition in a concentration from about 3 mol. % to about 12 mol. %. The clad glass composition may be substantially free from alkali metals and compounds containing alkali metals.

While reference has been made herein to a specific phase-separable clad glass composition used for forming the glass cladding layers 104a, 104b, it should be understood that other glass compositions may be used to form the glass cladding layers 104a, 104b of the laminated glass article 100 so long as the clad glass compositions are phase-separable.

In one or more embodiments, the glass composition from which the glass cladding layers 104a, 104b are formed may optionally include a colorant. The colorant is added to the clad glass composition to impart color to the glass cladding layers. Suitable colorants include, without limitation, Fe₂O₃, Cr₂O₃, Co₃O₄, CuO, Au, Ag, NiO, MnO₂, and V₂O₅, each of which may impart a unique color to the glass cladding layers. In some embodiments, combinations of two or more colorants may be used to achieve a desired color.

In embodiments described herein, the glass compositions used for forming the glass cladding layers 104a, 104b have a liquidus viscosity which renders them suitable for use in a fusion draw process and, in particular, for use as a glass cladding composition in a fusion lamination process. For example, in embodiments, the liquidus viscosity is greater than or equal to about 50 kPoise. In some other embodiments, the liquidus viscosity may be greater than or equal to 100 kPoise or even greater than or equal to 250 kPoise.

The laminated glass articles 100 described herein may have improved strength as a result of being laminated. For example, in embodiments, the glass cladding layers 104a, 104b are formed from a clad glass composition, which has a lower average coefficient of thermal expansion (CTE) than the glass core layer 102. For example, when glass cladding layers formed from a clad glass composition having a relatively low average CTE are paired with a glass core layer formed from a glass composition having a higher average CTE during a lamination process, the difference in the CTEs of the glass core layer and the glass cladding layers results in the formation of a compressive stress in the glass cladding layers upon cooling. In some embodiments described herein, the glass cladding layers are formed from clad glass compositions which have average CTEs less than or equal to about 40×10⁻⁷/° C. averaged over a range from 20° C. to 300° C. In some embodiments, the average CTE of the clad glass compositions may be less than or equal to about 37×10⁻⁷/° C. averaged over a range from 20° C. to 300° C. In yet other embodiments, the average CTE of the clad glass compositions may be less than or equal to about 35×10⁻⁷/° C. averaged over a range from 20° C. to 300° C.

As noted hereinabove, in some embodiments, the glass cladding layers 104a, 104b are formed from clad glass compositions, which are substantially free from alkali metals and compounds containing alkali metals including, without limitation, alkali oxides. Forming the glass cladding layers 104a, 104b from clad glass compositions, which are free from alkali oxides, such as K₂O, Na₂O, and Li₂O, may assist in lowering the CTE of the glass cladding layers that can influence the magnitude of the compressive stress achieved in the glass cladding layers following lamination. In addition, certain applications, such as electronic substrates and the like, may require that the surface of the laminated glass article is free from alkali ions in order to prevent the migration of highly mobile alkali ions from the glass to electronic devices deposited on the glass which can degrade the performance of the electronic devices by so-called “alkali poisoning.”

However, in some other embodiments, the glass cladding layers 104a, 104b may be formed from clad glass compositions, which contain alkali ions. In these embodiments, the presence of the alkali ions may facilitate chemically strengthening the glass by ion exchange, thereby improving the strength of the laminated glass article.

Referring now to FIG. 3, forming the glass cladding layers 104a, 104b from a clad glass composition that is phase-separable may facilitate the subsequent formation of a microstructure in the glass cladding layers by removing at least one of the phases from the glass. For example, in some embodiments, the glass cladding layers may be formed from a clad glass composition which phase separates by spinodal decomposition. In these embodiments, the glass cladding layers comprise an interconnected matrix formed from a first phase with at least one second phase dispersed within the first phase. In these embodiments, the at least one second phase is itself interconnected within the interconnected matrix formed by the first phase. One of the phases may be less susceptible to dissolution in water, alkaline solutions, and/or acidic solutions than the other phase. For example, in some embodiments, the second phase may be more susceptible to dissolution than the first phase. Accordingly, the at least one second phase may be selectively removed from the interconnected matrix formed by the first phase by dissolution in water and/or an acidic solution. As mentioned above, after the at least one second phase is removed from the glass, the glass cladding layers have a porous, interconnected matrix formed by the first phase, as is depicted in FIG. 3. The lighter regions in FIG. 3 shown the interconnected matrix formed by the first phase while the darker regions are the porosity of the interconnected matrix which corresponds to the space previously occupied by the at least one second phase.

Referring again to FIG. 1, the glass core layer 102 may be formed from a variety of different clad glass compositions so long as the composition of the glass core layer 102 is capable of being fused to the glass cladding layers 104a, 104b. In some embodiments, the glass core layer may include alkali metals and/or compounds containing alkali metals while, in other embodiments, the glass core layer may be substantially free from alkali metals and/or compounds containing alkali metals.

In embodiments in which the glass cladding layers 104a, 104b of the laminated glass article 100 are compressively stressed as a result of the lamination process, the glass core layer 102 is formed from a clad glass composition which has a high average coefficient of thermal expansion relative to the glass cladding layers 104a, 104b. As described herein, when glass cladding layers formed from clad glass compositions with low average CTEs are paired with a glass core layer formed from a glass composition which has a relatively higher average CTE during a fusion lamination process, the difference in the average CTEs of the glass core layer and the glass cladding layers results in the formation of a compressive stress in the glass cladding layers as the laminated structure cools without the structure being ion exchanged or thermally tempered.

In embodiments of the laminated glass article 100 described herein, the glass composition from which the glass core layer 102 is formed has a liquidus viscosity and a liquidus temperature suitable for fusion formation. For example, the glass composition from which the glass core layer 102 is formed may have a liquidus viscosity that is greater than or equal to about 35 kPoise. In embodiments, the liquidus viscosity of the glass composition from which the glass core layer 102 is formed is greater than or equal to 100 kPoise or even greater than or equal to 200 kPoise. The liquidus temperature of the glass composition from which the glass core layer is formed may be less than or equal to about 1400° C. In embodiments, the liquidus temperature is less than or equal to 1350° C. or even less than or equal to 1300° C.

In the embodiments described herein, the glass core layer 102 is formed from a glass composition which not phase-separable. This improves the mechanical integrity of the laminated glass article 100, particularly when the glass cladding layers 104a, 104b are formed such that the glass cladding layers have a porous, interconnected matrix.

In embodiments, the core glass composition generally comprises SiO₂ in a concentration less than or equal to about 64 mol. % in order to facilitate fusion forming the core glass composition. For example, in some embodiments, the concentration of SiO₂ in the core glass composition is greater than or equal to about 60 mol. % and less than or equal to about 64 mol. %. In some other embodiments, SiO₂ is present in the core glass composition in a concentration greater than or equal to about 61 mol. % and less than or equal to about 63 mol. %.

The concentration of Al₂O₃ in the core glass composition is generally less than or equal to about 12 mol. % in order to achieve the desired liquidus temperature to facilitate formation of the laminated glass article using fusion forming techniques. For example, in some embodiments, the concentration of Al₂O₃ in the core glass composition is greater than or equal to about 11 mol. % and less than or equal to about 10 mol. %. For example, in some embodiments, the concentration of Al₂O₃ in the core glass composition is greater than or equal to about 8 mol. % and less than or equal to about 12 mol. % or even greater than or equal to about 9 mol. % and less than or equal to about 11 mol. %.

In embodiments, B₂O₃ is generally present in the core glass composition in a concentration greater than or equal to about 6 mol. %. For example, in some embodiments, B₂O₃ is present in the core glass composition in a concentration greater than or equal to about 8 mol. % and less than or equal to about 11 mol. %. In other embodiments described herein, B₂O₃ is present in the core glass composition in a concentration greater than or equal to about 6 mol. % and less than or equal to about 10 mol. %.

Embodiment of the core glass composition used for the core glass may also include at least one alkaline earth oxide. The alkaline earth oxide generally improves the melting behavior of the core glass composition by lowering the temperature required for melting. Moreover, a combination of several different alkaline earth oxides assists in lowering the liquidus temperature of the core glass composition and increasing the liquidus viscosity of the core glass composition. The alkaline earth oxides included in the core glass composition are CaO, MgO, SrO and/or combinations thereof.

The alkaline earth oxide is present in the core glass composition in a concentration greater than or equal to about 9 mol. % and less than or equal to about 16 mol. %. In some embodiments, the core glass composition may comprise from about 11 mol. % to about 12 mol. % alkaline earth oxide. The core glass composition includes at least CaO as an alkaline earth oxide in a concentration greater than or equal to about 3 mol. % and less than or equal to about 9 mol. %. In some embodiments, the concentration of CaO may be greater than or equal to about 4 mol. % and less than or equal to about 8 mol. %. The alkaline earth oxide may further include MgO in a concentration greater than or equal to about 0 mol. % and less than or equal to about 8 mol. %. In some embodiments the concentration of MgO in the core glass composition may be greater than or equal to about 2 mol. % and less than or equal to about 7 mol. %. The alkaline earth oxide in the core glass composition may also include SrO in a concentration greater than or equal to about 0 mol. % and less than or equal 5 mol. %. In some embodiments, the SrO may be present in the core glass composition in a concentration from about 1 mol. % to about 4 mol. %.

The core glass composition of embodiments may optionally include one or more fining agents. The fining agents may include, for example, SnO₂, As₂O₃, Sb₂O₃ and combinations thereof. The fining agents may be present in the core glass composition in an amount greater than or equal to about 0 mol. % and less than or equal to about 0.5 mol. %. In exemplary embodiments, the fining agent is SnO₂. In these embodiments, SnO₂ may be present in the core glass composition in a concentration which is greater than about 0 mol. % and less than or equal to about 0.2 mol. % or even less than or equal to about 0.15 mol. %.

Accordingly, and with reference again to FIG. 1, in embodiments, the core glass 102 may be formed from a core glass composition which includes from about 60 mol. % to about 64 mol. % SiO₂; from about 8 mol. % to about 12 mol. % Al₂O₃; and from about 6 mol. % to about 10 mol. % B₂O₃ as glass network formers. The core glass composition from which the core glass is formed may further include from about 9 mol. % to about 16 mol. % alkaline earth oxide. The alkaline earth oxide includes at least CaO. The CaO may be present in the core glass composition in a concentration from about 4 mol. % to about 8 mol. %.

While reference has been made herein to a specific core glass composition used for forming the core glass 102, it should be understood that other core glass compositions may be used to form the core glass 102 of the laminated glass article 100.

In embodiments described herein, the core glass compositions used for forming the core glass 102 has a liquidus viscosity which renders it suitable for use in a fusion draw process and, in particular, for use as a glass core composition in a fusion lamination process. For example, in embodiments, the liquidus viscosity is greater than or equal to about 50 kPoise. In some other embodiments, the liquidus viscosity may be greater than or equal to 100 kPoise or even greater than or equal to 250 kPoise.

Referring again to FIG. 1, the glass core layer 102 may be formed from a variety of different core glass compositions so long as the composition of the glass core layer 102 is capable of being fused to the glass cladding layers 104a, 104b. In some embodiments, the glass core layer may include alkali metals and/or compounds containing alkali metals while, in other embodiments, the glass core layer may be substantially free from alkali metals and/or compounds containing alkali metals.

In embodiments in which the glass cladding layers 104a, 104b of the laminated glass article 100 are compressively stressed as a result of the lamination process, the glass core layer 102 is formed from a core glass composition which has a high average coefficient of thermal expansion relative to the glass cladding layers 104a, 104b. As described herein, when glass cladding layers formed from core glass compositions with low average CTEs are paired with a glass core layer formed from a core glass composition which has a relatively higher average CTE during a fusion lamination process, the difference in the average CTEs of the glass core layer and the glass cladding layers results in the formation of a compressive stress in the glass cladding layers as the laminated structure cools without the structure being ion exchanged or thermally tempered. In some embodiments, the glass core layer may be formed from core glass compositions, which have an average coefficient of thermal expansion (CTE) which is greater than or equal to about 40×10⁻⁷/° C. in a range from 20° C. to 300° C. In embodiments, the average CTE of the core glass composition of the glass core layer may be greater than or equal to about 60×10⁻⁷/° C. in a range from 20° C. to 300° C. In one or more embodiments, the average CTE of the core glass composition of the glass core layer may be greater than or equal to about 80×10⁻⁷/° C. averaged over a range from 20° C. to 300° C.

In embodiments of the laminated glass article 100 described herein, the core glass composition from which the glass core layer 102 is formed has a liquidus viscosity and a liquidus temperature suitable for fusion formation. For example, the core glass composition from which the glass core layer 102 is formed may have a liquidus viscosity that is greater than or equal to about 35 kPoise. In embodiments, the liquidus viscosity of the core glass composition from which the glass core layer 102 is formed is greater than or equal to 100 kPoise or even greater than or equal to 200 kPoise. The liquidus temperature of the core glass composition from which the glass core layer is formed may be less than or equal to about 1400° C. In embodiments, the liquidus temperature is less than or equal to 1350° C. or even less than or equal to 1300° C.

It should be understood that in embodiments where the cladding layer comprises alkali metal oxides, an ion exchange treatment may be conducted to increase the mechanical properties of the laminated glass article. Any conventional ion exchange process suitable for the glass composition of the cladding layers may be used.

It should also be understood that the transmittance and reflectance disclosed herein is directed to a glass article without any coating on the porous region, and particularly without any antireflective coatings on the porous region. As provided in detail above, the porous region itself manipulates.

### EXAMPLES

Embodiments will be further clarified by the following examples.

### Example 1

A laminated glass article having a total thickness of 0.7 mm was formed using a fusion draw method. The glass core was 540 μm thick and had a composition of 62.40 mol. % SiO₂, 10.89 mol. % Al₂O₃, 9.78 mol. % B₂O₃, 5.37 mol. % CaO, 2.24 mol. % K₂O, 6.23 mol. % MgO, 3.03 mol. % SrO, and 0.07 mol. % SnO₂. Fused to each major surface of the core was a cladding layer (two in total) each having a thickness of 70 μm and a composition of 64.64 mol. % SiO₂, 7.38 mol. % Al₂O₃, 16.45 mol. % B₂O₃, 8.14 mol. % CaO, 2.21 mol. % MgO, 1.11 mol. % SrO, and 0.07 mol. % SnO₂.

The laminated glass article formed by a fusion draw method was then subjected to a heat treatment at a temperature of 760° C. for 75 minutes to introduce phase separation. Once the heat treatment was complete, an etching treatment in 2.0 vol. % hydrofluoric acid solution was conducted for 90 seconds to produce a porous region. After the etching treatment, the laminated glass article was submerged in a water bath for 120 seconds.

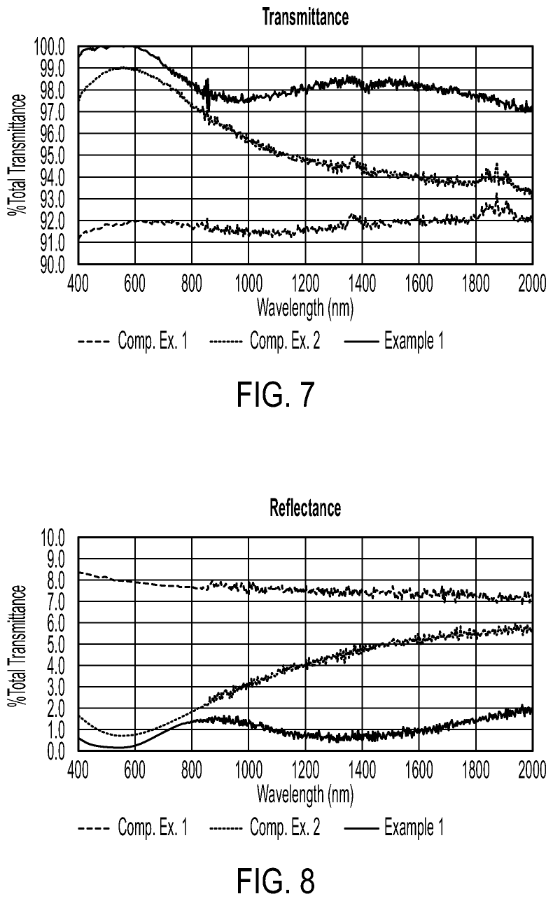

The laminated glass article had a porous region thickness of 375 nm at its surfaces as shown in the tunneling electron microscope (TEM) image in FIG. 6C. As shown in FIG. 7, the transmittance at LiDAR wavelengths is greater than or equal to 98% and the reflectance, as shown in FIG. 8, is less than 1% at LiDAR wavelengths.

### Comparative Example 1

A laminated glass article was formed by fusion draw method as described in Example 1. A heat treatment was performed on the laminated glass article at a temperature of 800° C. for 30 minutes and then the laminated glass article was allowed to cool to room temperature. No etching was performed on this comparative example.

As shown in the TEM image of FIG. 6A, no porous region is present at the surface of the laminated glass article. Moreover, FIG. 7 shows that the transmittance in both the visible spectrum an at LiDAR wavelengths is significantly lower in Comparative Example 1 than in Example 1, and FIG. 8 shows that the reflectance in both the visible spectrum and at LiDAR wavelengths is significantly lower in Comparative Example 1 than in Example 1.

### Comparative Example 2

A laminated glass article as described in Example 1 was formed by a fusion draw method. The laminated glass article was then subjected to a heat treatment at a temperature of 800° C. for 30 minutes to introduce phase separation. Once the heat treatment was complete, an etching treatment in 2.0 vol. % hydrofluoric acid solution was conducted for 30 seconds to produce a porous region. After the etching treatment, the laminated glass article was submerged in a water bath for 60 seconds.

The laminated glass article had a porous region thickness of 150 nm at its surfaces as shown in the TEM image in FIG. 6B. Moreover, FIG. 7 shows that the transmittance in both the visible spectrum an at LiDAR wavelengths is significantly lower in Comparative Example 2 than in Example 1, and FIG. 8 shows that the reflectance in both the visible spectrum and at LiDAR wavelengths is significantly lower in Comparative Example 2 than in Example 1.

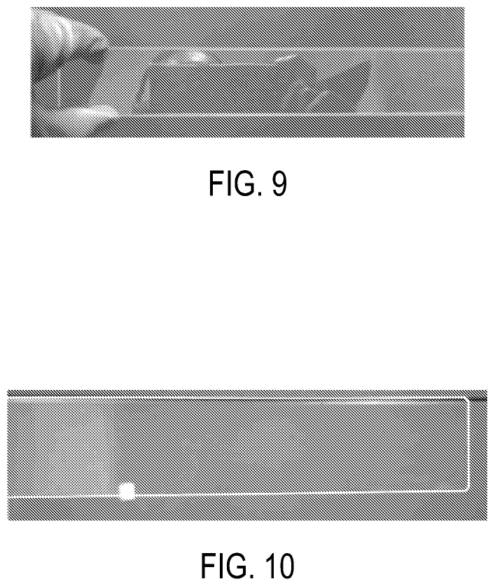

FIG. 9 shows an image of the laminated glass article of Comparative Example 1, which has significant reflectance in the visible region as shown by visibility of the individual taking the picture. In contrast, FIG. 10 shows an image of the laminated glass article of Example 1 with little reflectance and from a shadow on the left half of the sample that is missing on the right half. The sample remains optically transparent as further demonstrated by FIG. 10.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A laminated glass article comprising:
a glass core layer;
at least one glass cladding layer fused to the glass core layer, the at least one glass cladding layer having a porous region at an outer surface thereof, wherein
the laminated glass article has a transmittance across an entire spectrum from about 875 nm to about 2000 nm that is greater than or equal to 97.0%, and
the laminated glass article has a reflectance across an entire spectrum from 875 nm to 2000 nm that is less than or equal to 3.0%.

2. The laminated glass article of claim 1, wherein the laminated glass article has a transmittance across an entire visible spectrum that is greater than or equal to 97.0%.

3. The laminated glass article of claim 1, wherein the laminated glass article has a reflectance across an entire visible spectrum that is less than or equal to 1.5%.

4. The laminated glass article of claim 1, wherein
the laminated glass article has a transmittance across an entire spectrum from about 1200 nm to about 1800 nm that is greater than or equal to 97.5%,
the laminated glass article has a reflectance across the entire spectrum from 900 nm to 2000 nm that is less than or equal to 2.0%,
the laminated glass article has a transmittance across the entire visible spectrum that is greater than or equal to 99.5%, and
the laminated glass article has a reflectance across the entire visible spectrum that is less than or equal to 1.0%.

5. The laminated glass article of claim 4, wherein the laminated glass article has transmittance across an entire spectrum from 1500 nm to 1600 nm that is greater than 98%.

6. The laminated glass article of claim 4, wherein the laminated glass article has a reflectance across an entire spectrum from 1500 nm to 1600 nm that is less than 0.8%.

7. The laminated glass article of claim 1, wherein the porous region has an average pore size that is greater than or equal to 10 nm and less than or equal to 200 nm.

8. The laminated glass article of claim 1, wherein the porous region has an average pore size that is greater than or equal to 20 nm and less than or equal to 150 nm.

9. The laminated glass article of claim 1, wherein the porous region has a porosity that is greater than or equal 0.16 and less than or equal to 0.22.

10. The laminated glass article of claim 1, wherein a thickness t of the porous region is:
$$t = \frac{n λ}{4}$$
where λ is a wavelength of LiDAR electromagnetic radiation from 905 nm to 1600 nm, and n is an odd number.

11. The laminated glass article of claim 1, wherein a thickness of the porous region is greater than or equal to 350 nm and less than or equal to 450 nm.

12. The laminated glass article of claim 1, wherein a thickness of the porous region is greater than or equal to 375 nm and less than or equal to 400 nm.

13. The laminated glass article of claim 1, wherein the laminated glass article has a surface roughness that is less than or equal to 50 nm.

14. A method for forming a laminated glass article comprising:
obtaining a laminated glass article have a glass core layer and at least one cladding layer, wherein the at least one cladding layer is comprised of a phase-separable glass composition;
heating the laminated glass article to form a phase-separated cladding layer having an interconnected matrix comprising a first phase and discrete dispersed regions comprising a second phase dispersed in the interconnected matrix; and
etching the phase-separated cladding layer with an etching solution that etches away the discrete dispersed regions, thereby forming a porous region at a surface of the phase-separated cladding layer, wherein
the laminated glass article has a transmittance across an entire spectrum from about 900 nm to about 2000 nm that is greater than or equal to 97.0%, and
the laminated glass article has a reflectance across an entire spectrum from 900 nm to 2000 nm that is less than or equal to 3.0%.

15. The method of claim 14, wherein heating the laminated glass article comprises holding the laminated glass article at a temperature that is above a strain point of a glass that comprises the at least one cladding layer and that is below a softening point of the glass that comprises the at least one cladding layer for a time period that is greater than or equal to 1 minute and less than or equal to 24 hours.

16. The method of claim 15, wherein the laminated glass article is heated to a temperature that is greater than or equal to 500° C. and less than or equal to 1100° C.

17. The method of claim 14, wherein etching the phase-separated cladding layer comprises etching the phase-separated cladding layer in an etching solution that comprises an acid in an amount greater than or equal to 0.5 vol. % and less than or equal to 10.0 vol. % for a time period that is greater than or equal to 60 seconds and less than or equal to 120 seconds.

18. The method of claim 17, wherein the acid is selected from the group consisting of hydrofluoric acid, hydrochloric acid, nitric acid, sulfuric acid, sodium hydroxide potassium hydroxide, buffered oxide etchants (BOEs), or combinations thereof.

19. The method of claim 14, wherein heating the laminated glass article comprises holding the laminated glass article at a temperature that is above a strain point of the glass that comprises the at least one cladding layer and that is below a softening point of the glass that comprises the at least one cladding layer for a time period that is greater than or equal to 70 and less than or equal to 80 minutes, and
etching the phase-separated cladding layer comprises etching the phase-separated cladding layer in an etching solution that comprises an acid in an amount greater than or equal to 1.5 vol. % and less than or equal to 2.0 vol. % for a time period that is greater than or equal to 80 seconds and less than or equal to 100 seconds.

20. The method of claim 14, wherein after etching the phase-separated cladding layer, the laminated glass article is submerged in a room temperature water bath for a time period that is greater than or equal to 5 seconds and less than or equal to 300 seconds.
